(19) United States
(12) Patent Application Publication
(10) Pub. No.: US 2025/0225972 A1
(43) Pub. Date: Jul. 10, 2025

(54) NOISE SUPPRESSION DEVICE AND METHOD FOR A MOTOR VEHICLE

(71) Applicant: Bayerische Motoren Werke Aktiengesellschaft, Muenchen (DE)

(72) Inventors: Jens Heinemann, Muenchen (DE); Christoph Riebel, Muenchen (DE); Cedric Baroghel, Muenchen (DE)

(21) Appl. No.: 18/851,011

(22) PCT Filed: Nov. 25, 2022
(86) PCT No.: PCT/EP2022/083271

§ 371 Date: Sep. 25, 2024

(30) Foreign Application Priority Data
Apr. 28, 2022 (DE) 10 2022 110 296.3

(51) Int. Cl. G10K 11/178

(52) U.S. Cl. CPC G10K 11/17823; G10K 11/17873; G10K 2210/12821; G10K 2210/129; G10K 2210/3027; G10K 2210/501

(57) ABSTRACT

A noise suppression device for a motor vehicle includes one or more accelerometers and an evaluation device. A number of accelerometers detect vibrations that may be generated by wheels of the motor vehicle which are movable on a road surface and which may produce a noise in an interior of the motor vehicle. The evaluation device determines acoustic signals from the detected vibrations that are suitable for at least partly suppressing the noise when emitted in the interior of the motor vehicle. The number of accelerometers is less than or equal to a total number of vehicle axles of the motor vehicle.

The present application is the U.S. national phase of PCT Application PCT/EP2022/083271 filed on Nov. 25, 2022, which claims priority of German patent application No. 10 2022 110 296.3 filed on Apr. 28, 2022, the entire contents of which are incorporated herein by reference.

### TECHNICAL FIELD

The present disclosure relates to devices and methods for noise suppression for a motor vehicle.

### BACKGROUND

Driver assistance systems are increasingly being used in modern motor vehicles. These include, for example, head-up displays, parking aids, navigation systems, and also active noise suppression systems for reducing the volume of ambient noise in a vehicle interior to as low as possible. These assistance systems are intended to relieve the driver in particular, so that they can concentrate on driving the vehicle and the traffic. In addition, reducing ambient noise can also be beneficial for other occupants of motor vehicles. For example, when consuming media content, such as music or films. Ambient noise includes in particular driving noises that can be caused by an engine of the motor vehicle and also rolling noise of tires on a road. As the speed of the motor vehicle increases, these ambient noises may increase in volume, which also increases in the interior of the motor vehicle. To counteract this, noise suppression systems can be provided for motor vehicles. These noise suppression systems can be complex and expensive, as a variety of accelerometers can be used to detect vibration signals that need to be further evaluated.

There is a need for providing a simpler sound suppression system for motor vehicles.

### SUMMARY

The above-described need, as well as others, are achieved by one or more embodiments disclosed herein.

A first aspect is a noise suppression device for a motor vehicle, having: (i) a number of accelerometers for detecting vibrations which may be generated by wheels of the motor vehicle which can be moved on a road surface and which may produce noise in an interior of the motor vehicle; (ii) an evaluation device configured to determine acoustic signals from the vibrations detected that are capable of suppressing at least some of the noise when they are emitted in the interior of the motor vehicle; (iii) wherein the number of accelerometers is less than or equal to a total number of vehicle axles of the motor vehicle.

The terms ‘contains’, ‘includes’, ‘involves’, ‘has’, ‘with’, or any other variant thereof is intended to cover non-exclusive inclusion. For example, a method or device that includes or has a list of elements is not necessarily limited to those elements, but may include other elements which are not expressly listed or which are related to such a method or are inherent in such a device.

Further, unless expressly stated otherwise, “or” refers to an inclusive or and not an exclusive “or”. For example, a condition A or B is satisfied by one of the following conditions: A is true (or present) and B is false (or not present), A is false (or not present) and B is true (or present), and both A and B are true (or present).

The term “a” as used herein is defined as “one or more”. The terms “another” and “a further” and any other variant thereof are to be understood in the sense of “at least one other”.

The term ‘several’, as used in the present case, is to be understood as meaning ‘two or more’.

The term “configured” or “set up” to perform a particular function (and any variations thereof) is to be understood as meaning that the corresponding device already exists in a design or setting in which it can perform the function or it can at least be set in such a way-i.e. is configurable-such that it can execute the function after the appropriate setting. The configuration can be done, for example, by setting the parameters of a process sequence or switches or the like to activate or deactivate functionalities or settings. In particular, the device may have several predetermined configurations or modes of operation, so that configuration can be carried out by selecting one of these configurations or modes of operation.

By means of the device according to the first aspect, it can be achieved that a lower computational effort is required for an evaluation of the acceleration signals because a limitation of the number of accelerometers to one accelerometer for each vehicle axle is envisaged. This also results in a corresponding cost saving compared with a device in which, for example, two accelerometers are provided for each vehicle axle. Likewise, the necessary means for the transfer of the detected vibrations can be saved. Overall, the embodiments disclosed herein may enable a simpler noise suppression system for motor vehicles.

The preferred embodiments of the device are described below, each of which, unless expressly excluded or technically infeasible, can be combined with each other as well as with the other described aspects.

In some designs, the accelerometers have a first accelerometer and a second accelerometer, wherein the first accelerometer is mechanically couple to a first region of a of the motor body vehicle, which is mechanically coupled to a first chassis of a first wheel of the movable wheels, in particular in the vicinity of a bearing of the first chassis, and the second accelerometer is mechanically coupled to a second region of the body of the motor vehicle that is mechanically coupled to a second chassis of a second wheel of the movable wheels which is mechanically coupled, in particular in the vicinity of a bearing of the second chassis, wherein the first wheel is arranged on a vehicle axle and side of the vehicle that is different from the second wheel. This allows vibrations from different sides of the vehicle and different vehicle axles to be measured or detected. This is advantageous because, although no more than one accelerometer is provided for each vehicle axle, this arrangement enables the measurement of vibrations from both sides of the motor vehicle which may lead to noise in the interior of the motor vehicle and can therefore be taken into account in the noise suppression. The mechanical coupling of the accelerometers to the body of the motor vehicle also enables detection of the vibrations that are introduced into the body and that can reach the interior in this way.

In some embodiments, one of the first accelerometer and the second accelerometer is integrated into the evaluation device. This allows a spatial distance between the accelerometer and the evaluation device to be reduced, whereby signal propagation times from the accelerometer to the evaluation device can be reduced. This can lead to improved noise suppression, since a time difference between the noise produced and the acoustic signals for at least partly suppressing the noise can be reduced. Furthermore, a cable connection between the accelerometer and the evaluation device can be omitted, as well as an additional housing for the accelerometer.

In some embodiments, the first accelerometer is designed to act in a first direction, and the second accelerometer is designed to act in a second direction different from the first direction. This makes it possible to use accelerometers axle dependently. The first accelerometer can act in a lateral direction, and can take into account steering movements of the motor vehicle, and can be advantageously located on a chassis on a front axle. If the second accelerometer can detect height movements, it could be advantageously arranged on a chassis on a rear axle.

In some embodiments, at least one of the first accelerometer and the second accelerometer is biaxial.

This allows the accelerometer to detect vibrations that act in two different directions. This makes it possible for the accelerometer to be flexibly arranged locationally. In addition, a more precise evaluation of the vibrations can be carried out, whereby an acoustic signal for suppressing the noise in the interior can be determined, which can cause a greater degree of suppression.

In some embodiments, at least one of first the accelerometer and the second accelerometer is triaxial. This allows for an even more precise evaluation of the vibrations, whereby an acoustic signal can be obtained for suppressing the noise in the interior which can cause an even greater degree of suppression.

In some embodiments, the device has a compression spring sensor for detecting vibrations. A compression spring sensor may already be fitted as standard in a motor vehicle, so that using such a compression spring sensor does not incur any additional costs. In addition, a compression spring sensor can detect low-frequency signals, whereby a better acoustic signal for suppressing the third noise can be generated as part of an evaluation. A low-frequency signal can have a frequency that is less than 100 Hz.

In some embodiments, the device has a height sensor for detecting vibrations. A height sensor can already be installed as standard in a motor vehicle, so that there are no additional costs associated with the use of such a height sensor. In addition, a height sensor can detect higher-frequency signals, especially higher-frequency signals than the compression spring sensor, whereby a better acoustic signal can be generated for suppressing the fourth sound in the context of an evaluation.

A second aspect relates to a motor vehicle having a device according to the first aspect.

A third aspect relates to a method, in particular a computer-implemented noise suppression method for a motor vehicle, with the following steps (i) providing a number of accelerometers; (ii) detecting vibrations by the number of accelerometers, wherein the vibration are generated by the wheels of the motor vehicle moving on a road surface, and can generate a sound in an interior of the motor vehicle; (iii) determining acoustic signals using the vibrations detected, wherein the acoustic signals are capable of at least partly suppressing the noise when emitted in the interior of the motor vehicle, wherein the number of accelerometers provided is less than or equal to the total number of vehicle axles of the motor vehicle.

The features and advantages explained in relation to the first aspect can also apply correspondingly to the other aspects.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows schematically a motor vehicle with a device according to an exemplary embodiment in a plan view;

FIG. 2 shows a wheel unit in a side view; and

FIG. 3 shows a flow diagram to illustrate a preferred embodiment of a method according to the disclosure.

### DETAILED DESCRIPTION

In the figures, the same reference signs are used throughout for the same or mutually corresponding elements of the invention.

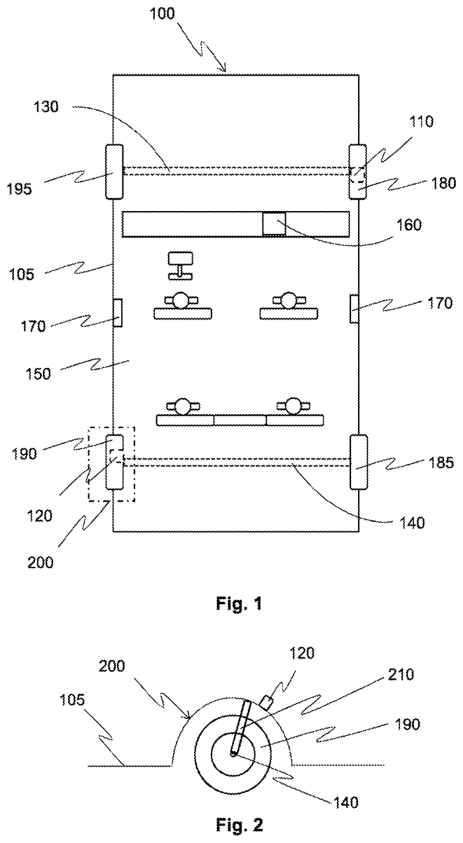

FIG. 1 schematically shows a motor vehicle 100 with a device according to the invention based on an exemplary embodiment in a plan view. The motor vehicle 100 has a body 105, a front axle 130 and a rear axle 140. A first accelerometer 110 is arranged on the front axle 130 on a right-hand side of the motor vehicle 100 in the direction of travel on a first wheel 180 or on a chassis (not shown here) of the first wheel 180. A second accelerometer 120 is arranged on the rear axle 140 on a left side of the motor vehicle 100 in the direction of travel on a second wheel 190 or on a chassis 210 of the second wheel 190, see FIG. 2. The chassis of the first wheel 180 and the chassis 210 of the second wheel 190 are each mechanically coupled or connected to the body 105. The first accelerometer 110 and/or the second accelerometer 120 can each be mechanically coupled to the body in the vicinity of a bearing (not shown here) of the corresponding chassis 210. This can make it possible to essentially detect the vibrations that are introduced to the body 105 and can thereby reach the interior 150. On the rear axle 140 there is also a third wheel 185 arranged on the right side of the motor vehicle 100 and a fourth wheel 195 arranged on the front axle 130 on the left side of the motor vehicle 100. This arrangement means that the first accelerometer 110 and the second accelerometer 120 are offset diagonally to each other in the direction of travel. This allows both vibrations that occur on the left side of the motor vehicle 100 and vibrations that occur on the right side of the motor vehicle 100 to be detected or measured. Vibrations that occur on the front axle 130 as well as vibrations that occur on the rear axle 140 can also be detected. These oscillations or vibrations that are essentially caused by rolling friction of rolling wheels 180, 185, 190 and 195 of the motor vehicle 100 on a road produce noises which can be perceived in an interior 150 of the motor vehicle 100. These noises can reach a disturbing volume at a medium speed, in a range of about 20 to 100 km/h of the motor vehicle 100 and/or on an uneven road surface. At higher speeds, i.e. above 100 km/h, noises caused by rolling friction can still occur. However, as the speed increases, wind noises can increase, which can overlay the perceptible volume of noise caused by rolling friction in the interior 150.

The motor vehicle 100 also has an evaluation device 160 which can be used to evaluate vibrations or acceleration signals detected by the first accelerometer 110 and by the second accelerometer 120. The evaluation device 160, using the detected vibrations or acceleration signals, determines acoustic signals which can act as anti-noise signals to the noises caused by the vibrations. An anti-noise signal is an acoustic signal that is formed with an opposite phase by 180° relative to another acoustic signal, in this case the sounds in the interior 150, so that when the signals are overlaid on each other the signals cancel each other out. As a result, noises generated in the interior 150 of the motor vehicle 100 due to the rolling of the first wheel 180 and the second wheel can be reduced or suppressed by means of a superposition with the determined acoustic signal.

The determined acoustic signals are forwarded by the evaluation device 160 to loudspeakers 170 arranged in the interior 150 of the motor vehicle 100. The acoustic signals detected are emitted through the loudspeakers 170, whereby the noise is at least partly reduced or suppressed.

Furthermore, FIG. 1 shows a wheel unit 200 that has the second wheel 190 and the second accelerometer 120. This wheel unit 200 is described further in FIG. 2.

FIG. 2 schematically shows a wheel unit 200 in a side view. The wheel unit 200 has the second wheel 190, an associated chassis 210, and a second accelerometer 120. A cross-section of the rear axle 140 is also shown schematically. The is second accelerometer 120 mechanically coupled or connected to the chassis 210. The chassis 210 in turn is mechanically coupled or connected to the body 105. As a result, vibrations or oscillations of the wheel 190 caused by the wheel 190 rolling on a road will be transferred via the chassis 210 and the body 105 to the second accelerometer 120. The second accelerometer 120 can detect these vibrations.

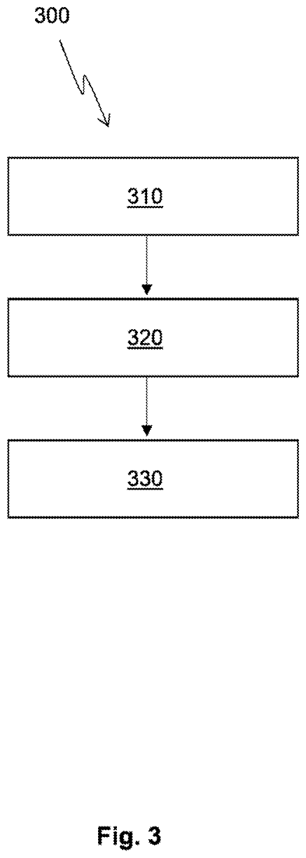

FIG. 3 shows a flow diagram 300 to illustrate a preferred embodiment of the method according to the invention for noise suppression for a motor vehicle, with the following steps:

In a first step 310 of the method, a number of accelerometers 110, 120 are provided.

In a further step step 320 of the method, vibrations are detected by the number of accelerometers 110, 120, wherein the vibrations are generated by wheels 180, 190 of the motor vehicle 100 moving on a road surface, and are capable of producing a noise in an interior 150 of the motor vehicle 100.

In a further step 330 of the method, acoustic signals are determined using the detected vibrations, wherein the acoustic signals are suitable for at least partly suppressing the noise when they are emitted in the interior of the motor vehicle, wherein the number of accelerometers 110, 120 provided is less than or equal to a total number of vehicle axles 130, 140 of the motor vehicle 100.

While at least one exemplary embodiment has been described above, it should be noted that there are a large number of variations on this. It should also be noted that the exemplary embodiments described are only non-limiting examples and are not intended to limit the scope, applicability or configuration of the devices and methods described herein. Rather, the above description should be understood by the person skilled in the art such that various changes may be made in the operation and arrangement of the elements described in an exemplary embodiment without thereby departing from the subject-matter defined in the attached d claims and the legal equivalents thereof.

### LIST OF REFERENCE SIGNS

100 Motor vehicle
105 Body
110 First accelerometer
120 Second accelerometer
130 Front axle
140 Rear axle
150 Interior of vehicle
160 Evaluation device
170 Loudspeaker
180, 185, 190, 195 First to fourth wheel
200 Wheel unit
210 Chassis
300 Flow diagram
310 Providing accelerometers
320 Detecting vibrations
330 Determining acoustic signals

1.-10. (canceled)

11. A noise suppression device for a motor vehicle, comprising:
a number of accelerometers for detecting vibrations that may be generated by wheels of the motor vehicle which are movable on a road surface and which may produce a noise in an interior of the motor vehicle;
an evaluation device configured to determine acoustic signals from the detected vibrations that are suitable for at least partly suppressing the noise when emitted in the interior of the motor vehicle;
wherein a number of accelerometers is less than or equal to a total number of vehicle axles of the motor vehicle.

12. The device as claimed in claim 11, wherein the accelerometers include a first accelerometer and a second accelerometer, wherein the first accelerometer is mechanically coupled to a first region of a body of the motor vehicle that is mechanically coupled to a first chassis of a first wheel of the movable wheels, and the second accelerometer is mechanically coupled to a second region of the body of the motor vehicle that is mechanically coupled to a second chassis of a second wheel of the movable wheels, wherein the first wheel is arranged on a vehicle axle that is different a second vehicle axis on which the second wheel is arranged, and is located on side of the vehicle different from a side of the vehicle on which the second wheel is located.

13. The device as claimed in claim 12, wherein at least the first accelerometer is integrated in the evaluation device.

14. The device as claimed in claim 12, wherein the first accelerometer is configured to act in a first direction and the second accelerometer is configured to act in a second direction that is different from the first direction.

15. The device as claimed in claim 14, wherein at least one of the first accelerometer and the second accelerometer is of a biaxial form.

16. The device as claimed in claim 12, wherein at least one of the first accelerometer and the second accelerometer is of a biaxial form.

17. The device as claimed in claim 16, further comprising a compression spring sensor configured to detect vibrations.

18. The device as claimed in claim 17, further comprising a height sensor configured to detect vibrations.

19. The device as claimed in claim 16, wherein at least the first accelerometer is integrated in the evaluation device.

20. The device as claimed in claim 16, wherein the first accelerometer and the second accelerometer are of the biaxial form.

21. The device as claimed in claim 16, wherein the first accelerometer is of the biaxial form and the second accelerometer is of a triaxial form.

22. The device as claimed in claim 12, wherein at least one of the first accelerometer and the second accelerometer is of a triaxial form.

23. The device as claimed in claim 11, further comprising a compression spring sensor configured to detect vibrations.

24. The device as claimed in claim 23, further comprising a height sensor configured to detect vibrations.

25. The device as claimed in claim 11, further comprising a height sensor configured to detect vibrations.

26. A motor vehicle having a device as claimed in claim 11.

27. A noise suppression method for a motor vehicle, the method comprising:
providing a number of accelerometers;
detecting vibrations using the number of accelerometers, wherein the vibrations are generated by wheels of the motor vehicle moving on a road surface, and are capable of producing a noise in an interior of the motor vehicle;
determining acoustic signals using the detected vibrations, wherein the acoustic signals are suitable for at least partly suppressing the noise when emitted in the interior of the motor vehicle;
wherein a number of the accelerometers provided is less than or equal to a total number of vehicle axles of the motor vehicle.
